(19) United States
(12) Patent Application Publication
(10) Pub. No.: US 2020/0180388 A1
(43) Pub. Date: Jun. 11, 2020

(54) MOTOR VEHICLE WITH SPACE SAVING HEATING, VENTILATION AND AIR CONDITIONING SYSTEM ARCHITECTURE

(71) Applicant: FORD GLOBAL TECHNOLOGIES, LLC, Dearborn, MI (US)

(72) Inventors: Steve Michael Kahrs, Canton, MI (US); John Azar, LaSalle (CA); Manfred Koberstein, Troy, MI (US); Emily Obert, Ferndale, MI (US)

(21) Appl. No.: 16/215,043

(22) Filed: Dec. 10, 2018

(51) Int. Cl. B60H 1/00; B60H 1/24; B60H 1/26; B60H 3/06

(52) U.S. Cl. CPC B60H 1/00028; B60H 1/00564; B60H 1/247; B60H 2001/00214; B60H 3/0608; B60H 2001/00185; B60H 1/26

(57) ABSTRACT

A motor vehicle includes a motor compartment, a passenger compartment and a firewall separating the motor compartment from the passenger compartment. The motor vehicle also includes a heating, ventilation and air conditioning system. That heating, ventilation and air conditioning system includes an HVAC inlet subassembly and an HVAC air distribution subassembly in the passenger compartment and a transition duct in the motor compartment directing an airstream from the HVAC inlet subassembly to the HVAC air distribution subassembly.

### TECHNICAL FIELD

This document relates generally to the motor vehicle equipment field and, more particularly, to a new and improved motor vehicle incorporating a heating, ventilation and air conditioning (HVAC) system architecture as well as to a method of increasing space in a passenger compartment of a motor vehicle.

### BACKGROUND

Automotive designers are often challenged to increase the space in the interior/passenger compartment of motor vehicles to better accommodate motor vehicle occupants. Toward this end, a new and improved motor vehicle is provided that incorporates a heating, ventilation and air conditioning system with a unique architecture adapted or configured to increase the spaciousness of the passenger compartment.

### SUMMARY

In accordance with the purposes and benefits described herein, a new and improved motor vehicle is provided. That motor vehicle comprises a motor compartment, a passenger compartment, a firewall separating the motor compartment from the passenger compartment and a heating, ventilation and air conditioning (HVAC) system. That HVAC system includes (a) an HVAC inlet subassembly in the passenger compartment, (b) an HVAC air distribution subassembly in the passenger compartment and (c) a transition duct in the motor compartment that is adapted for directing an airstream from the HVAC inlet subassembly to the HVAC air distribution subassembly.

The HVAC inlet subassembly may include a fresh air inlet, a recirculation air inlet and a recirculation door to control the flow of air through the fresh air inlet and the recirculation air inlet. The HVAC inlet subassembly may also include a blower.

The HVAC distribution subassembly may include an evaporator core. The HVAC distribution subassembly may also include a heater core. The HVAC distribution subassembly may include at least one blend door and at least one mode door.

In one or more of the many possible embodiments of the motor vehicle, the HVAC distribution subassembly may include an air filter. In one or more of the many possible embodiments of the motor vehicle, the transition duct may include an air filter. Further, the transition duct may include a service door to access the air filter. Further, the transition duct may have an upstream end connected to the HVAC inlet subassembly and a downstream end connected to the HVAC air distribution subassembly.

In one or more of the many possible embodiments of the motor vehicle, the firewall may form one wall of the transition duct. In one or more of the many possible embodiments of the motor vehicle, the transition duct may include a clamp, of a type known in the art, that is adapted to hold a component selected from a group consisting of a line or a hose of a type associated with the operating systems of the motor vehicle.

In accordance with an additional aspect, a new and improved method is provided for increasing the space in a passenger compartment of a motor vehicle including an HVAC system. That method comprises the steps of: (a) locating an HVAC inlet subassembly and an HVAC air distribution subassembly of the HVAC system on a passenger compartment side of a firewall of the motor vehicle and (b) locating a transition duct adapted for directing an airstream from the HVAC inlet subassembly to the HVAC air distribution subassembly, on a motor compartment side of the firewall.

The method may also include the step of forming one wall of the transition duct with the firewall.

In the following description, there are shown and described several preferred embodiments of the motor vehicle and the related method of increasing space in a passenger compartment of a motor vehicle including an HVAC system. As it should be realized, the motor vehicle and method are capable of other, different embodiments and their several details are capable of modification in various, obvious aspects all without departing from the motor vehicle and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the motor vehicle and method and together with the description serve to explain certain principles thereof.

FIG. 1 is a schematic illustration of one possible embodiment of the new and improved motor vehicle.

FIG. 2 is a schematic detailed view of the HVAC system of the motor vehicle illustrated in FIG. 1.

FIG. 3a is a detailed schematic view of a first possible embodiment of the transition duct of the HVAC system illustrated in FIG. 2.

FIG. 3b is a detailed schematic view of a second possible embodiment of the transition duct of the HVAC system illustrated in FIG. 2.

FIG. 4 is a schematic illustration of a second possible embodiment of the motor vehicle.

FIG. 5 is a schematic view of a third possible embodiment of the motor vehicle.

FIG. 6 is a schematic view of a fourth possible embodiment of the motor vehicle.

FIG. 7a is a detailed schematic view of a filter secured in a transition duct of any of the possible embodiments of the motor vehicle.

FIG. 7b is a view similar to FIG. 7a but illustrating the opening of the service door and removal of the filter from the transition duct.

Reference will now be made in detail to the present preferred embodiments of the motor vehicle and the related method, examples of which are illustrated in the accompanying drawing figures.

### DETAILED DESCRIPTION

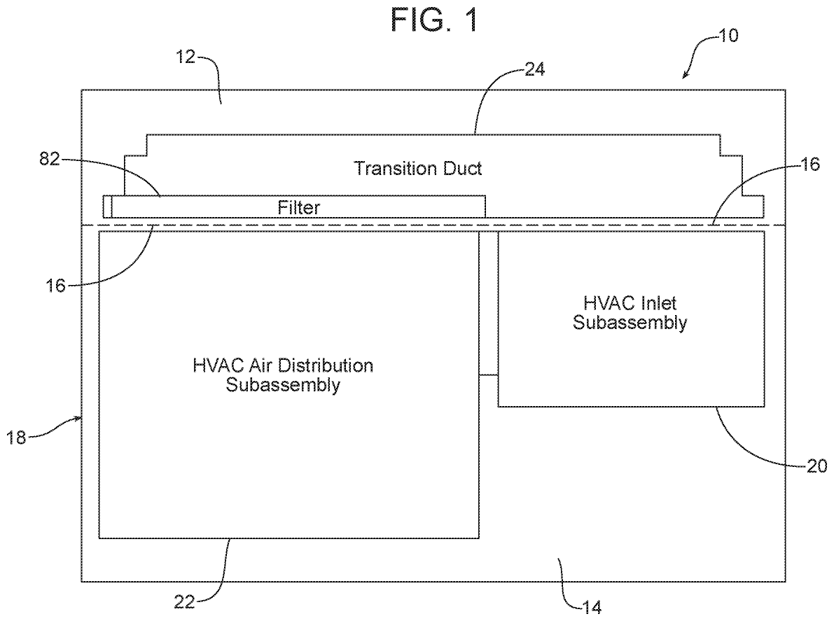

Reference is now made to FIG. 1 which schematically illustrates a first possible embodiment of the new and improved motor vehicle 10. That motor vehicle 10 includes a motor compartment 12, a passenger compartment 14 and a firewall 16 separating the motor compartment from the passenger compartment. As is known in the art, the motor and other operating systems (not shown) of the motor vehicle are housed in the motor compartment while the passenger compartment is configured or adapted to receive and transport occupants of the motor vehicle in a spacious, climate controlled and inviting environment.

As further illustrated in FIG. 1, the motor vehicle 10 also includes an HVAC system generally designated by reference numeral 18. As illustrated in FIG. 1, that HVAC system 18 includes an HVAC inlet subassembly 20 in the passenger compartment 14, an HVAC air distribution subassembly 22 also in the passenger compartment and a transition duct 24. The transition duct 24 is configured or adapted to direct an airstream from the HVAC inlet subassembly 20 to the HVAC air distribution subassembly 22. The transition duct 24 is carried in the motor compartment 12 of the motor vehicle 10.

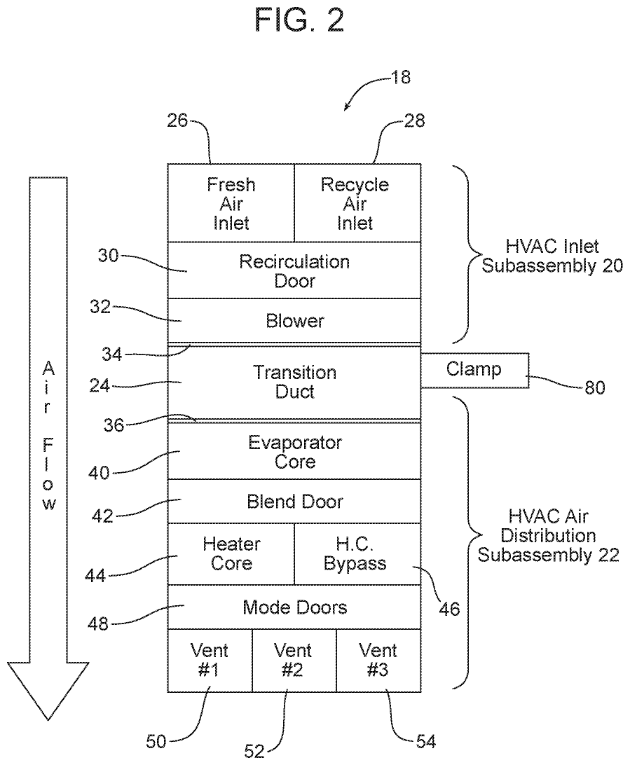

Reference is now made to FIG. 2 illustrating the details of the HVAC system 18. As illustrated, the HVAC inlet subassembly 20 includes a fresh air inlet 26, a recycle air inlet 28 and a recirculation door 30 adapted to control the flow of (a) fresh air from the ambient environment through the fresh air inlet and (b) recycle air from the passenger compartment through the recycle air inlet. As is known in the art, the recirculation door 30 may allow only the intake of (a) fresh air through the fresh air inlet 26, (b) recycled air through the recycle air inlet 28 or (c) any combination of fresh air and recycle air. The HVAC inlet subassembly 20 also includes a blower 32 that is adapted or configured to draw fresh air and/or recycle air through the respective fresh air inlet 26 and recycle air inlet 28.

The transition duct 24 has an upstream end 34 connected to the HVAC inlet subassembly 20 and a downstream end 36 connected to the HVAC air distribution subassembly 22. The airstream discharged by the blower 32 passes through the transition duct 24 to the HVAC air distribution subassembly 22.

In the illustrated embodiment, the HVAC air distribution subassembly 22 includes an evaporator core 40, a blend door 42, a heater core 44, a heater core bypass 46, one or more mode doors 48, a first vent, 50 a second vent 52 and third vent 54. When the airstream first reaches the HVAC air distribution subassembly 22 it passes through the evaporator core 40. The airstream is cooled and dehumidified in the evaporator core 40. The airstream discharged from the evaporator core 40 is then directed by the blend door 42 through the heater core 44 where the airstream is heated or through the heater core bypass 46 or any combination of the two.

The now fully conditioned airstream is directed by the mode doors 48 to one or more of the vents, 50, 52, 54. For example, the first vent 50 may be a windshield defroster/defogger, the second vent 52 may be a dashboard vent and the third vent 54 may be a floor vent. Of course, other vent arrangements can be provided if desired.

While not shown, it should be appreciated that the HVAC system 18 is controlled and operated by a control module of a type known in the art that controls the speed of the blower 32, the operation of the recirculation door 30, blend door 42 and mode doors 48 and all other aspects of the HVAC system 18 in accordance with instructions from appropriate control software.

The architecture of the HVAC system 18 provides a number of substantial benefits and advantages. Significantly, all electrical components of the HVAC system 18 are housed in either the HVAC inlet subassembly 20 or the HVAC air distribution subassembly 22 on the passenger compartment 14 side of the firewall 16 where they are fully protected from the environmental elements. In contrast, the transition duct 24 for directing air from the HVAC inlet subassembly 20 to the HVAC air distribution subassembly 22 is provided on the motor compartment 12 side of the firewall 16 in what may otherwise be an area of wasted space. Advantageously, by providing the transition duct 24 on the motor compartment 12 side of the firewall 16, space is conserved in the passenger compartment 14. This is particularly significant since the area concealed behind the dashboard is often quite crowded to the point that often limits designer freedom. Significantly, by moving the transition duct 24 into the motor compartment 12, additional space is provided in the passenger compartment resulting in greater design freedom and a resulting increase in space for occupants of the passenger compartment 14.

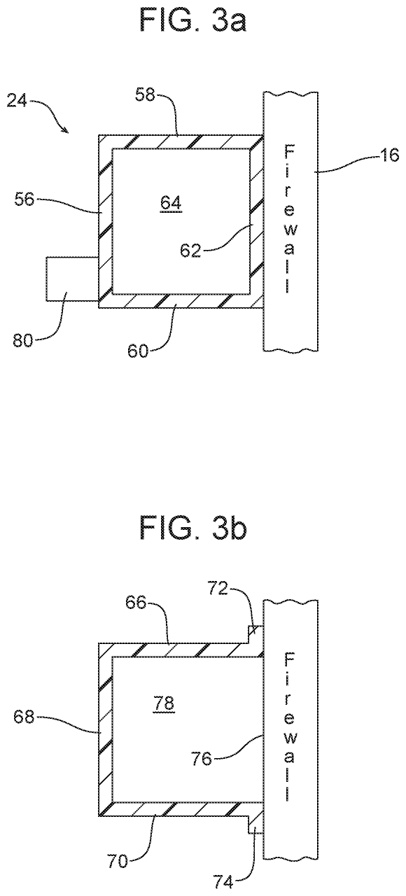

Reference is now made to FIG. 3a which is a schematic cross sectional view of one possible embodiment of the transition duct 24. As illustrated in FIG. 3a, the transition duct 24 comprises a first wall 56, a second wall 58, a third wall 60 and a fourth wall 62 enclosing or defining an air passageway 64. As illustrated, the fourth wall 62 abuts the firewall 16 on the motor compartment side of the firewall.

In an alternative embodiment of the transition duct 24 illustrated in FIG. 3b, the duct includes a first wall 66, a second wall 68 and a third wall 70. The first wall 66 includes a first mounting flange 72 and the third wall 70 includes a second mounting flange 74. The mounting flanges 72 and 74 abut the motor compartment side of the firewall 16 so that the portion 76 of the firewall 16 between the flanges 72, 74 forms one wall of the transition duct 24 defining the air pathway 78.

As schematically illustrated in FIGS. 2 and 3a, a clamp 80, of a type known in the art, may be carried on the transition duct 24. Such a clamp 80 is configured or adapted to hold a component such as a line or hose of one of the operating systems of the motor vehicle 10. In this way, the transition duct 24 may function as a routing component for such a line or hose.

In the embodiment of the motor vehicle 10 illustrated in FIG. 1, an air filter 82 is provided in the transition duct 24 at the downstream end 36 on the motor compartment 12 side of the firewall 16 opposite the HVAC air distribution subassembly 22.

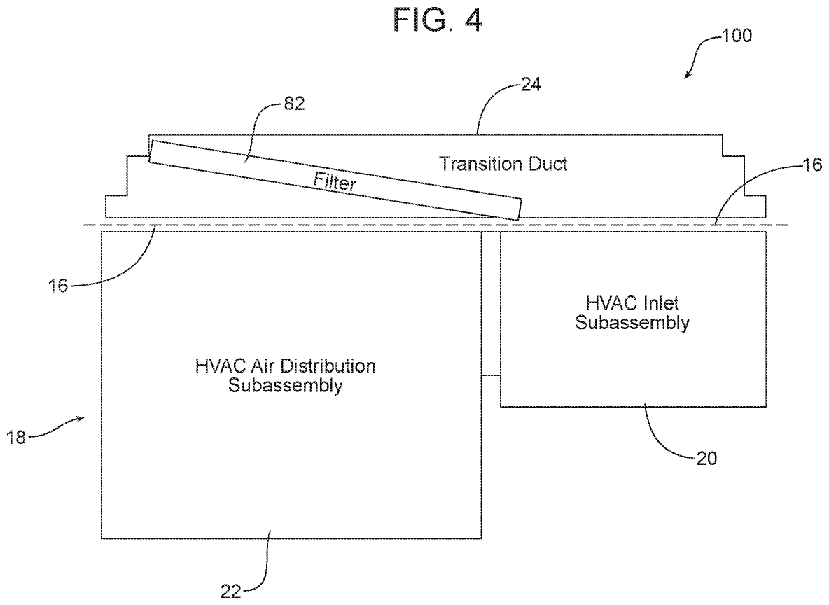

In a second possible embodiment of the motor vehicle 100 illustrated in FIG. 4, the air filter 82 is oriented diagonally across the transition duct 24 where it can filter the airstream passing from the HVAC inlet subassembly 20 through the transition duct 24 to the HVAC air distribution subassembly 22.

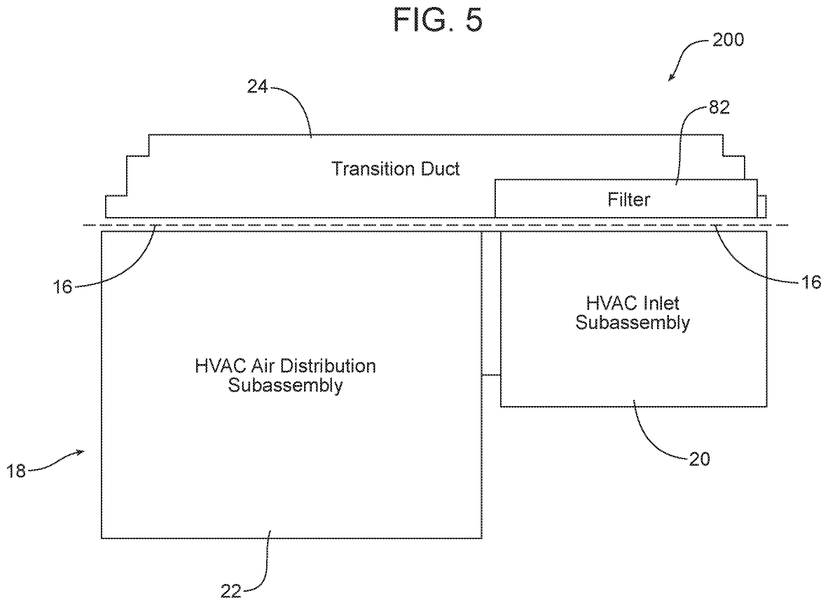

In the alternative embodiment of the motor vehicle 200 illustrated in FIG. 5, the air filter 82 is provided in the transition duct 24 at the upstream end 34 thereof on the motor compartment 12 side of the firewall 16 opposite the HVAC inlet subassembly 20 where it can filter air passing from that HVAC inlet subassembly through the transition duct 24 to the HVAC air distribution subassembly 22.

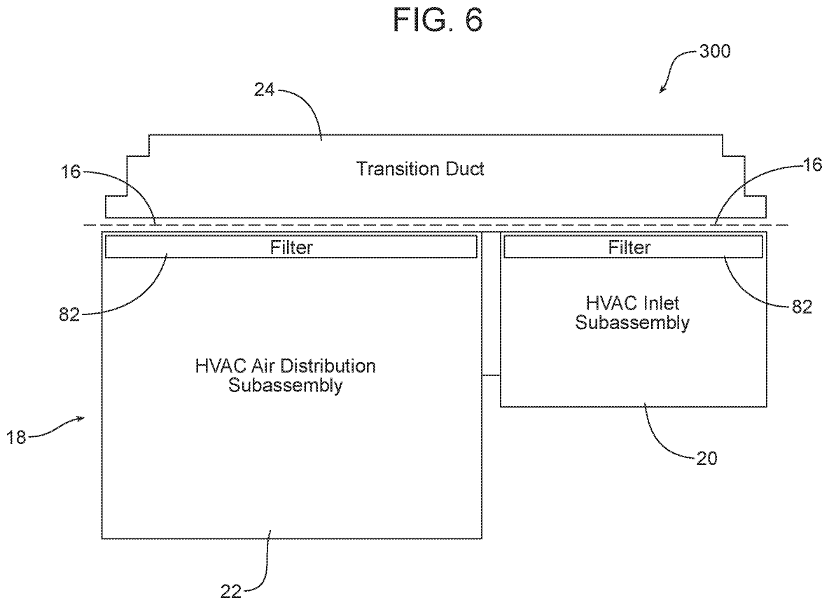

In the additional embodiment of the motor vehicle 300 illustrated in FIG. 6, two alternative filters 82 are provided (that is, one or the other, not both): one at the outlet of the HVAC inlet subassembly 20 leading to the transition duct 24 and one at the inlet of the HVAC air distribution subassembly 22 receiving the airstream from the transition duct 24.

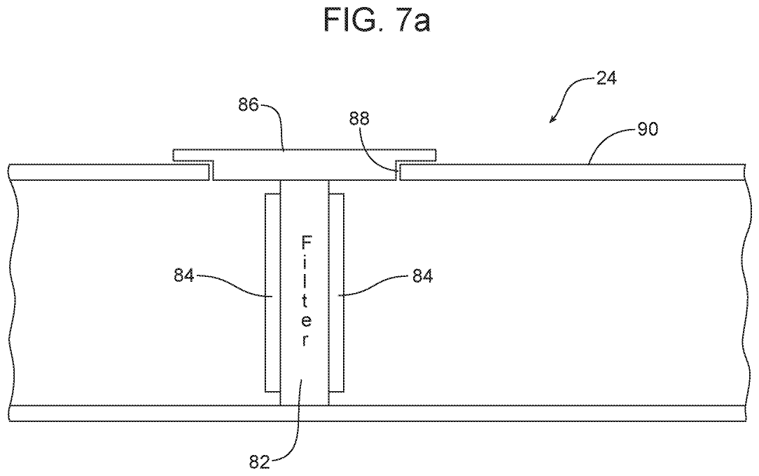

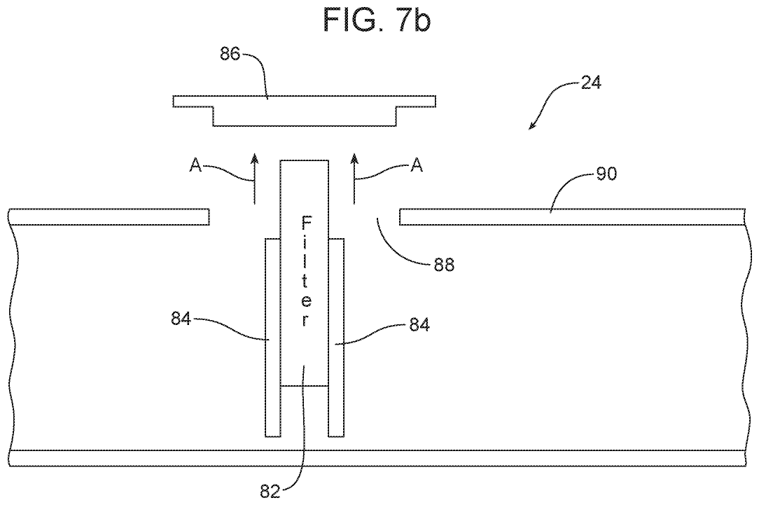

FIGS. 7a and 7b are detailed schematic illustrations of an air filter 82 received in a transition duct 24 and held in place in that duct by guide ribs 84. As illustrated in FIG. 7a, a service door 86 closes an access opening 88 in the upper wall 90 of the transition duct 24. The service door 86 may be held in place by friction fit or any appropriate fastener. One may easily service the air filter 82 by opening the service door 86 and sliding the filter 82 upward in the direction of action arrows A so that the filter is removed from between the ribs 84 through the access opening 88. See FIG. 7b. After inserting a new filter 82 between the ribs 84, the access door 86 may again be closed to seal the access opening 88 and hold the filter in position within the duct 24. Here it should be appreciated that a filter 82 positioned in the transition duct 24 on the motor compartment 12 side of the firewall 16 may be easily accessed and serviced as compared to an air filter located on the passenger compartment 14 side of the firewall 16 where such a filter is concealed beneath the dashboard of the motor vehicle.

Consistent with the above description, a method is provided of increasing space in a passenger compartment 14 of a motor vehicle 10 including an HVAC system 18. That method includes the steps of locating an HVAC inlet subassembly 20 and an HVAC air distribution subassembly 22 of the HVAC system on a passenger compartment 14 side of a firewall 16 of the motor vehicle and locating a transition duct 24, directing an airstream from the HVAC inlet subassembly to the HVAC air distribution subassembly, on a motor compartment 12 side of the firewall 16. Still further, the method may include the step of forming one wall of the transition duct 24 with a portion 76 of the firewall 16.

The foregoing has been presented for purposes of illustration and description. It is not intended to be exhaustive or to limit the embodiments to the precise form disclosed. Obvious modifications and variations are possible in light of the above teachings. For example, the transition duct 24 may be shaped in a manner so as to function as a diffuser. All such modifications and variations are within the scope of the appended claims when interpreted in accordance with the breadth to which they are fairly, legally and equitably entitled.

What is claimed:

1. A motor vehicle, comprising:
a motor compartment;
a passenger compartment;
a firewall separating said motor compartment from said passenger compartment; and
a heating, ventilation and air conditioning (HVAC) system including:
(a) an HVAC inlet subassembly in said passenger compartment;
(b) an HVAC air distribution subassembly in said passenger compartment; and
(c) a transition duct directing an airstream from said HVAC inlet subassembly to said HVAC air distribution subassembly in said motor compartment.

2. The motor vehicle of claim 1, wherein said HVAC inlet subassembly includes a fresh air inlet, a recirculation air inlet and a recirculation door.

3. The motor vehicle of claim 2, wherein said HVAC inlet subassembly also includes a blower.

4. The motor vehicle of claim 3, wherein said HVAC distribution subassembly includes an evaporator core.

5. The motor vehicle of claim 4, wherein said HVAC distribution subassembly includes a heater core.

6. The motor vehicle of claim 5, wherein said HVAC distribution subassembly includes at least one blend door and at least one mode door.

7. The motor vehicle of claim 6, wherein said HVAC inlet subassembly includes an air filter.

8. The motor vehicle of claim 6, wherein said transition duct includes an air filter.

9. The motor vehicle of claim 8, wherein said transition duct includes a service door to access said air filter.

10. The motor vehicle of claim 1, wherein said transition duct has an upstream end connected to said HVAC inlet subassembly and a downstream end connected to said HVAC air distribution subassembly.

11. The motor vehicle of claim 1, wherein said firewall forms one wall of said transition duct.

12. The motor vehicle of claim 1, wherein said transition duct includes a clamp adapted to hold a component selected from a group consisting of a line or hose.

13. The motor vehicle of claim 1, wherein said transition duct is also a diffuser.

14. A method of increasing space in a passenger compartment of a motor vehicle including a heating, ventilation and air conditioning (HVAC) system, comprising:
locating an HVAC inlet subassembly and an HVAC air distribution subassembly of said HVAC system on a passenger compartment side of a firewall of said motor vehicle; and
locating a transition duct directing an airstream from said HVAC inlet subassembly to said HVAC air distribution subassembly on a motor compartment side of said firewall.

15. The method of claim 14 including forming one wall of said transition duct with said firewall.
